(19) United States
(12) Patent Application Publication
(10) Pub. No.: US 2026/0286159 A1
(43) Pub. Date: Sep. 24, 2026

(54) Preparation and Application of LEDUV-C Curable Waterborne Wood Coating Resin

(71) Applicant: Binju Wu, Foshan (CN)

(72) Inventor: Binju Wu, Foshan (CN)

(21) Appl. No.: 19/465,002

(22) Filed: Jan. 30, 2026

(51) Int. Cl. C09D 15/00; C09D 5/02; C09D 7/43; C09D 7/45; C09D 7/47; C09D 7/61; C09D 7/65; C09D 7/80; C09D 175/16

(52) U.S. Cl. CPC C09D 15/00; C09D 5/022; C09D 5/025; C09D 5/027; C09D 5/028; C09D 7/43; C09D 7/45; C09D 7/47; C09D 7/61; C09D 7/65; C09D 7/80; C09D 175/16

(57) ABSTRACT

This invention discloses a preparation method and application of LEDUV-curable water-based wood coatings resin, belonging to the field of water-based coating technology. The process comprises the following steps: First, add the improved UV-curable fluorinated water-based polyurethane emulsion to a stainless steel dispersion tank. Under low-speed dispersion, incorporate the specified proportions of polyurethane thickener, preservative, dispersant, defoamer, wetting agent, nano additive, and light-blocking agent. After 25 minutes of high-speed dispersion, switch to low-speed dispersion. Then add the specified proportions of water-based wax emulsion, defoamer, leveling agent, silicone surfactant, and a modified 35% photoinitiator diacetylphosphine oxide solution. After another 25 minutes of high-speed dispersion, the LEDUV-curable water-based wood coatings resin is prepared. This invention significantly enhances the coatings hydrophobicity, water resistance, and pigment wetting performance while demonstrating excellent hardness, tensile strength, and yellowing resistance. Particularly suitable for wood furniture spray application, it achieves superior film transparency, surface smoothness, and comprehensive performance.

### TECHNICAL FIELD

This invention belongs to the field of water-based coatings technology, specifically involving a method for preparing and applying an LED UV-cured water-based wood coating resin.

### BACKGROUND

Wooden furniture, as the core category of home consumption market, has both practical function and cultural and aesthetic value, and its market size has long occupied more than 30% of the global furniture market.

In the production chain of wooden furniture, the spray coating process serves as a critical factor determining product appearance, surface protection, and added value. Through strategic paint selection and precision spraying techniques, this process not only masks natural wood imperfections but also imparts essential functionalities like scratch resistance, yellowing prevention, and moisture-proofing. Simultaneously, it achieves diverse visual and tactile effects including matte, glossy, and skin-like finishes, effectively meeting consumers demand for personalized home furnishings.

At present, oil-based 2K polyurethane wood paint is generally used for wood furniture spraying, which has the following problems: poor wetting performance, easy to lead to poor dispersion of pigments and fillers, resulting in rough surface and uneven gloss after spraying.

To address these issues, this study proposes a preparation method and application of LEDUV-cured water-based wood coatings resin.

### INVENTION DESCRIPTION

To address the issues mentioned in the background technology, this invention provides a preparation method and application of LEDUV-cured water-based wood coatings resin. The resin significantly enhances the coatings hydrophobicity, water resistance, and pigment wetting performance, while demonstrating excellent hardness, tensile strength, and yellowing resistance. Particularly suitable for wood furniture spray coating applications, it achieves superior film transparency, surface smoothness, and comprehensive performance characteristics.

To achieve the aforementioned objectives, the present invention provides a technical solution: a method for preparing an LEDUV-curing water-based wood coating resin, comprising the following steps:
The improved UV-curable fluorinated aqueous polyurethane emulsion was added to a stainless steel dispersion tank. Under low-speed dispersion, the preset proportions of polyurethane thickener, preservative, dispersant, defoamer, wetting agent, nano additive, and light-blocking agent were introduced. After 25 minutes of high-speed dispersion, the process was switched to low-speed dispersion. Subsequently, the specified ratios of water-based wax emulsion, defoamer, leveling agent, silicone surfactant, and a modified 35% photoinitiator diacetyl phosphine oxide solution were added. Following another 25 minutes of high-speed dispersion, the LEDUV-curable water-based wood coating resin was prepared.

Further, the specific preparation steps of the improved ultraviolet curing fluorinated aqueous polyurethane emulsion include:
Add the quantitative polycarbonate diol to acetone and stir until completely dissolved to obtain polycarbonate diol-acetone solution;
Add the specified amount of 2,2-dihydroxypropionic acid to N,N-dimethylformamide and stir until fully dissolved to obtain the 2,2-dihydroxypropionic acid-N,N-dimethylformamide solution.

Add a certain amount of methacrylic acid-2-hydroxyethyl ester to acetone and stir until completely dissolved to obtain methacrylic acid-2-hydroxyethyl ester-acetone solution;

Nitrogen gas is introduced through the inlet of a four-neck flask equipped with a condenser, nitrogen inlet, stirring bar, and thermometer. Under nitrogen protection, a measured amount of isophorone diisocyanate and dibutyltin dilaurate are added, and the temperature is gradually raised to 45° C. The pre-measured polycarbonate diol-acetone solution is added through a dropping funnel at a rate of 1 drop every 2-3 seconds. The reaction proceeds for 3 hours, with viscosity adjusted using acetone. The free isocyanate content is titrated by the dibutylamine method. Upon reaching the theoretical value, the temperature is gradually increased to 65° C. The pre-measured 2,2-dihydroxymethylpropanoic acid-N,N-dimethylformamide solution is added through the dropping funnel at a rate of 1 drop every 2-3 seconds, followed by another 3-hour reaction. The free isocyanate content is titrated again by the dibutylamine method. After reaching the theoretical value, the pre-measured methacrylic acid-2-hydroxyethyl acetate-acetone solution is added through the dropping funnel at a rate of 1 drop every 2-3 seconds for a half-terminated reaction lasting 3 hours. The free isocyanate content is titrated once more by the dibutylamine method. Upon reaching the theoretical value, the pre-measured azobisisobutyronitrile is added through the dropping funnel at a rate of 1 drop every 2-3 seconds. The temperature is gradually raised to 75° C., and the pre-measured methacrylic acid dodecyl fluorohexyl ester is added through the dropping funnel at a rate of 1 drop every 2-3 seconds for a 6-hour reaction. During this process, viscosity is adjusted using ethyl acetate and acetone. The temperature is gradually cooled to 65° C., and the pre-measured 4-methoxy. The capping reaction between phenol and pentaerythritol triacrylate was conducted for 4 hours, with the 2270 cm⁻¹ peak confirmed by infrared spectroscopy. ⁻¹ The isocyanate peak was completely eliminated, resulting in UV-cured fluorinated polyurethane resin.

Cool the UV-cured fluorinated polyurethane resin to room temperature, add triethylamine in the specified amount, and stir at high speed for 30 minutes. Then add deionized water in the specified amount for emulsification treatment, and continue for 1 hour. Let it stand for 12 hours, and remove acetone by rotary evaporation under vacuum to obtain UV-cured fluorinated aqueous polyurethane emulsion.

Furthermore, the polycarbocarbonated diol is added in a quantity of 160 ml, 2,2-dihydroxymethylpropanoic acid in 13.4 g, methacrylic acid-2-hydroxyethyl ester in 13 ml, isophorone diisocyanate in 88.9 ml, methacrylic acid dodecyl fluoroheptyl ester in 19.5 ml, pentaerythritol triacrylate in 29.8 ml, and deionized water in 680 ml.

Further, the specific preparation steps of the improved 35% photoinitiator diacetyl phosphine oxide solution include:
Add the measured amount of dimethylmethane to the three-neck flask and stir at low speed. Slowly add the measured amount of photoinitiator diacetyl phosphine oxide, pass inert gas, and heat to 75° C. Stir for 1 h until completely dissolved to obtain the improved 35% photoinitiator diacetyl phosphine oxide solution.

In addition, the amount of dimethoxy methane added is 65 ml, and the amount of photoinitiator dicyloxy phosphine added is 35 ml.

Furthermore, the polyurethane thickener is RM8W produced by Dow Chemical Company of the United States; the preservative is LEX produced by Rohm and Haas of the United States; the dispersant is TEGO Dispers 760W produced by Evonik of Germany; the defoaming agent is TEGO Foamex 825 produced by Evonik of Germany; the wetting agent is TEGO Wet 270 produced by Evonik of Germany; the nano additive is Fumed Silica A200 produced by Degussa Group of Germany; the light-blocking agent is K-500 produced by Toyo Kasei Corporation of Japan; the water-based wax emulsion is 2558 produced by Longhai Chemical Company; the defoaming agent is TEGO Foamex 810 produced by Evonik of Germany; the leveling agent is BYK378 produced by Bick Chemical of Germany; the silicone surfactant is DC57 produced by Dow Corning of the United States.

Furthermore, the optimized formulation comprises the following components in the specified proportions: UV-cured fluorinated aqueous polyurethane emulsion (86.4%), polyurethane thickener (0.5%), preservative (0.5%), dispersant (0.5%), defoamer (0.5%), wetting agent (0.2%), nano additive (0.4%), light-blocking agent (0.5%), water-based wax emulsion (0.5%), leveling agent (4%), silicone surfactant (3.5%), and 35% photoinitiator diacetylphosphine oxide solution (2.5%).

Furthermore, the application of the LEDUV-curable water-based wood coatings resin prepared by the described method in the field of wood furniture spray coating.

Compared with the existing technology, the beneficial effects of the present invention are:

This invention significantly improves the hydrophobicity, water resistance and pigment wetting performance of the coating, and exhibits excellent hardness, tensile strength and anti-yellowing properties. It is especially suitable for the field of wood furniture spraying, and can achieve excellent film transparency, surface smoothness and comprehensive performance.

### IMPLEMENTATION

The technical solutions of the embodiments of the present invention will be described in detail with reference to the accompanying drawings. It should be noted that the described embodiments represent only a portion of the inventions implementations, not the complete set. Furthermore, all other embodiments developed by skilled professionals in the field without requiring inventive effort fall within the scope of protection provided by the present invention.

This invention provides a technical solution: a method for preparing an LEDUV-cured water-based wood coating resin, comprising the following steps:
The modified UV-curable fluorinated aqueous polyurethane emulsion was added to a stainless steel dispersion tank. Under low-speed dispersion, the preset proportions of polyurethane thickener, preservative, dispersant, defoamer, wetting agent, nano additive, and light-blocking agent were introduced. After 25 minutes of high-speed dispersion, the process was switched to low-speed dispersion. Subsequently, the specified ratios of water-based wax emulsion, defoamer, leveling agent, silicone surfactant, and a modified 35% photoinitiator diacetyl phosphine oxide solution were added. Following another 25 minutes of high-speed dispersion, the LEDUV-curable water-based wood coating resin was prepared.

Specifically, the specific preparation steps of the improved ultraviolet curing fluorinated waterborne polyurethane emulsion include:
Add the quantitative polycarbonate diol to acetone and stir until completely dissolved to obtain polycarbonate diol-acetone solution;
Add the specified amount of 2,2-dihydroxypropionic acid to N,N-dimethylformamide and stir until fully dissolved to obtain the 2,2-dihydroxypropionic acid-N,N-dimethylformamide solution.

Add a certain amount of methacrylic acid-2-hydroxyethyl ester to acetone and stir until completely dissolved to obtain methacrylic acid-2-hydroxyethyl ester-acetone solution;

Nitrogen gas is introduced through the inlet of a four-neck flask equipped with a condenser, nitrogen inlet, stirring bar, and thermometer. Under nitrogen protection, a measured amount of isophorone diisocyanate and dibutyltin dilaurate are added, and the temperature is gradually raised to 45° C. The pre-measured polycarbonate diol-acetone solution is added through a dropping funnel at a rate of 1 drop every 2-3 seconds. The reaction proceeds for 3 hours, with viscosity adjusted using acetone. The free isocyanate content is titrated by the dibutylamine method. Upon reaching the theoretical value, the temperature is gradually increased to 65° C. The pre-measured 2,2-dihydroxymethylpropanoic acid-N,N-dimethylformamide solution is added through the dropping funnel at a rate of 1 drop every 2-3 seconds, followed by another 3-hour reaction. The free isocyanate content is titrated again by the dibutylamine method. After reaching the theoretical value, the pre-measured methacrylic acid-2-hydroxyethyl acetate-acetone solution is added through the dropping funnel at a rate of 1 drop every 2-3 seconds for a half-terminated reaction lasting 3 hours. The free isocyanate content is titrated once more by the dibutylamine method. Upon reaching the theoretical value, the pre-measured azobisisobutyronitrile is added through the dropping funnel at a rate of 1 drop every 2-3 seconds. The temperature is gradually raised to 75° C., and the pre-measured methacrylic acid dodecyl fluorohexyl ester is added through the dropping funnel at a rate of 1 drop every 2-3 seconds for a 6-hour reaction. During this process, viscosity is adjusted using ethyl acetate and acetone. The temperature is gradually cooled to 65° C., and the pre-measured 4-methoxy. The capping reaction between phenol and pentaerythritol tris(3-acryloyl) ester was conducted for 4 hours, with the reaction being confirmed by infrared spectroscopy at 2270 cm⁻¹.⁻¹The isocyanate peak was completely eliminated, yielding UV-cured fluorinated polyurethane resin.

Cool the UV-cured fluorinated polyurethane resin to room temperature, add triethylamine in measured amounts, and stir at high speed for 30 minutes. Then add deionized water in measured amounts for emulsification treatment, continue for 1 hour, and let it stand for 12 hours. Remove acetone by rotary evaporation under vacuum conditions to obtain UV-cured fluorinated aqueous polyurethane emulsion.

Specifically, the formulation contains 160 ml of polycarbonate diol, 13.4 g of 2,2-dihydroxymethylpropanoic acid, 13 ml of 2-hydroxyethyl methacrylate, 88.9 ml of isophorone diisocyanate, 19.5 ml of dodecyl fluoroheptanoate, 29.8 ml of pentaerythritol triacrylate, and 680 ml of deionized water.

Specifically, the specific preparation steps of the improved 35% photoinitiator diacetyl phosphine oxide solution include:
Add the measured amount of dimethylmethane to the three-neck flask and stir at low speed. Slowly add the measured amount of photoinitiator diacyloxy phosphine, pass inert gas, and heat to 75° C. Stir for 1 h until completely dissolved to obtain the improved 35% photoinitiator diacyloxy phosphine solution.

Specifically, 65 ml of dimethoxy methane and 35 ml of photoinitiator diacetyl phosphine oxide were added.

Specifically, the polyurethane thickener is RM8W produced by Dow Chemical Company of the United States; the preservative is LEX produced by Rohm and Haas of the United States; the dispersant is TEGO Dispers 760W produced by Evonik of Germany; the defoaming agent is TEGO Foamex 825 produced by Evonik of Germany; the wetting agent is TEGO Wet 270 produced by Evonik of Germany; the nano additive is Fumed Silica A200 produced by Degussa Group of Germany; the light-blocking agent is K-500 produced by Toyo Kasei Corporation of Japan; the water-based wax emulsion is 2558 produced by Longhai Chemical Company; the defoaming agent is TEGO Foamex 810 produced by Evonik of Germany; the leveling agent is BYK378 produced by Bick Chemical of Germany; the silicone surfactant is DC57 produced by Dow Corning of the United States.

Specifically, the optimized formulation comprises: UV-cured fluorinated aqueous polyurethane emulsion, polyurethane thickener, preservative, dispersant, defoamer, wetting agent, nano-additive, light-blocking agent, aqueous wax emulsion, leveling agent, silicone surfactant, and a modified 35% photoinitiator diacetyl phosphine oxide solution. The specific addition ratios are: 86.4%:0.5%:0.5%:0.5%:0.2%:0.4%:0.5%:4%:3.5%, 0.2%, 0.4%, 0.4%, and 2.5%.

The infrared characterization of the UV-cured fluorinated aqueous polyurethane emulsion was performed using a Fourier transform infrared spectrometer (FT-IR, model FTLA2000-104, ABB BOMEN, Canada). The infrared absorption spectrum results were analyzed to determine the polymer structure.

2930 cm⁻¹ 2850 cm and 2850 cm⁻¹ The peaks indicate the stretching vibrations of —CH₃ and —CH₂ groups;

2270 cm⁻¹ No peak appeared in the reaction, confirming the complete reaction of isocyanate group;

1750 cm⁻¹ The peak corresponds to the stretching vibration of the carbonyl group (C═O) in —NHCOO—.

1260 cm⁻¹ The peak at the position represents the stretching vibration of the ether (C—O) bond in —NHCOO—.

1580 cm⁻¹ The peaks in the spectrum indicate the bending vibrations of the —NH— group and the stretching vibrations of the —CN— group in the —NHCOO— structure, confirming the successful synthesis of the ethyl carbamate (—NHCOO—) group.

1180 cm⁻¹ The peak indicates the stretching vibration of carbon-fluorine bond (—CF₂—), preliminarily confirming the copolymerization of dodecyl fluoroheptyl methacrylate with polyurethane and its successful incorporation into the polyurethane system, indicating the successful synthesis of UV-cured fluorinated aqueous polyurethane.

The ¹H NMR characterization of the UV-cured fluorinated aqueous polyurethane emulsion was performed using a Bruker AVANCE III 400 MHz NMR spectrometer (Switzerland). The results were analyzed with tetramethylsilane as the internal standard to determine the product structure. The ¹H NMR spectrum is shown below:
δ=4.06 ppm: proton peak of the methylene group (—NHCOO—CH₂—) adjacent to the urethane bond in pentaerythritol triacrylate.
δ=5.88 ppm and δ=6.41 ppm: proton peaks of the methylene group in the vinyl group of pentaerythritol triacrylate;
δ=6.12 ppm: The proton peak of the methylene group in the vinyl terminal of pentaerythritol triacrylate confirms its successful incorporation into the aqueous polyurethane system.
δ=0.92 ppm: proton peak of the methyl group (—CH₃) in 2,2-dihydroxymethylproionic acid;
δ=4.30 ppm: The proton peak of the methylene group (—NHCOO—CH₂—) adjacent to the urethane bond in 2,2-dihydroxymethylproionic acid confirms its successful incorporation into the aqueous polyurethane system.
δ=3.66 ppm: proton peak of the methylene group (—COO—CH₂—) adjacent to the ester group in 2-hydroxyethyl methacrylate.
δ=4.30 ppm: proton peak of the methylene group (—CH₂—OCO—) between the fluorocarbon chain and the ester group in dodecyl fluoroheptanoate.
δ=1.28 ppm: The proton peak of the methylene (—CH₂—) group formed by the reaction of the double bond between dodecyl fluoroheptanoate and 2-hydroxyethyl methacrylate confirms the successful copolymerization and incorporation into the aqueous polyurethane system.
δ=1.03 ppm: proton peak of the methyl group (—CH₃) in triethylamine;
δ=2.23 ppm: The proton peak of the methylene group (—CH₂—) in triethylamine confirms its successful neutralization of the carboxyl group in 2-hydroxyethyl methacrylate and incorporation into the aqueous polyurethane system.
δ=4.14 ppm: The proton peak of hydrogen in the urethane bond (—NHCOO—) indicates abundant urethane groups, confirming the successful synthesis of UV-curable fluorinated aqueous polyurethane.

¹⁹The FNMR spectrum results are as follows:
δ=−75.13 ppm: chemical shift of the terminal CF₃ group;
δ=−71.89 ppm: chemical shift of the —CF₃ group adjacent to the ester group;
δ=−75.64 ppm, δ=−75.93 ppm and δ=−76.19 ppm: The —CF— groups from chemical shift confirm the successful incorporation of dodecyl fluoroheptanoate into the aqueous polyurethane system.

Add 86.4% UV-cured fluorinated aqueous polyurethane emulsion to the stainless steel dispersion tank. Under low-speed dispersion, sequentially add 0.5%, 0.5%, 0.5%, 0.2%, 0.4%, 0.5%, and 4% of RM8W, TEGO Dispers 760W, TEGO Dispers 735W, TEGO Foamex 825, TEGO Wet 270, Fumed Silica A200, and light blocker K-500. After 25 minutes of high-speed dispersion, switch to low-speed dispersion. Then add 3.5%, 0.2%, 0.4%, 0.4%, and 2.5% of 2558, TEGO Foamex 810, BYK378, DC57, and an improved 35% photoinitiator diacetylphosphine oxide solution. Formulate a 500 g sample labeled as A.

Add 83.2% UV-cured fluorinated aqueous polyurethane emulsion to the stainless steel dispersion tank. Under low-speed dispersion, add 0.6%, 0.6%, and 7% of TEGO Dispers 760W, TEGO Dispers 735W, and light blocker K-500 respectively. Maintain high-speed dispersion for 25 minutes to prepare a 500 g sample labeled as A1.

Add 80% UV-cured fluorinated aqueous polyurethane emulsion to the stainless steel dispersion tank. Under low-speed dispersion, add 0.8%, 0.8%, and 10% of TEGO Dispers 760W, TEGO Dispers 735W, and light-blocking agent K-500 respectively. Maintain high-speed dispersion for 25 minutes to prepare a 500 g sample labeled as A2.

A, A1, and A2 were left undisturbed in the dark at 25° C. for 2 hours to evaluate resin wettability by measuring viscosity and fineness. Viscosity was determined using a rotational viscometer according to GB/T 10171-2017, while fineness was measured with a scraper fineness meter following the method specified in GB/T 6753.1-2007. The results are as follows:

| sample | A | A1 | A2 |
|---|---|---|---|
| dynamic viscosity | 1500 | 1570 | 1700 |
| (cps) | | | |
| fineness (μm) | 25 | 24 | 27 |

As shown in the table above, the LEDUV-cured water-based wood coatings resin demonstrates excellent wetting performance.

The tensile strength tests for A, A1, and A2 yielded the following results:

As the content of the light-blocking agent K-500 increases, the coatings tensile strength gradually improves while its elongation at break decreases. This phenomenon primarily occurs because the addition of siloxane segments increases the proportion of rigid chains while reducing the proportion of flexible chains. Furthermore, the high electronegativity of silicon enhances hydrogen bonding interactions within the system, leading to progressive improvement in tensile strength and a corresponding downward trend in elongation at break.

The transmittance of A, A1, and A2 was tested, with the results as follows:

As the concentration of light-blocking agent K-500 increases, the coatings light transmittance gradually decreases. When the content of dodecyl fluoroheptanoate (DFHMA) is below 6%, the coatings light transmittance exceeds 90%. However, when the DFHMA content reaches 10%, the transmittance drops to approximately 80%. This phenomenon is primarily attributed to excessive accumulation of silicon atoms on the coating surface. When the siloxane chain segments in the system approach saturation, the systems compatibility decreases, leading to phase separation and consequently reduced light transmittance.

The stability tests for A, A1, and A2 yielded the following results:

| sample | A | A1 | A2 |
|---|---|---|---|
| color stability | Off-white, | Off-white, | Off-white, |
| | translucent | translucent | translucent |
| mechanical | no sediment | no sediment | no sediment |
| stability | | | |
| Storage stability | 6 months | 6 months | 6 months |

As shown in the table, the emulsions appearance gradually shifts from transparent blue to milky white with increasing K-500 light-blocking agent content, primarily due to enlarged particle size. However, this change does not affect the emulsions storage stability. The siloxane modification significantly enhances the hardness and adhesion of waterborne polyurethane coatings, attributed to increased surface fluorocarbon chain segment enrichment. These segments provide protective shielding for non-siloxane segments, while elevated crosslinking density further strengthens the base films hardness. When the siloxane chain segments on the coating surface approach saturation, the magnitude of hardness variation gradually diminishes.

The dispersion tank was loaded with DSM3910 resin (DSM Synthetic Resin Co., Ltd.), film-forming agent BAC, propylene glycol methyl ether acetate, silica-based matting agent OK520, high-performance wax powder additive TF1780, polyamide wax anti-settling additive 6900-20X, surfactant M5, wetting and dispersing agent Efka4010, defoaming agent BYK052, surfactant M5, and silicone leveling agent BYK323 in the following proportions: 65%, 16.1%, 10%, 6%, 1%, 0.8%, 0.5%, 0.2%, 0.2%, and 0.2%. The mixture was dispersed at high speed for 20 minutes to achieve a fineness of 25 μm and viscosity of 1000-1400 [symbol] . Subsequently, it was blended with 45% isocyanate curing agent Covestro L75-1351 in a 100:50 ratio to produce an oil-based 2K polyurethane named A3.

Prepare three 400×400 cm medium-density fiberboard (MDF) panels coated with UV-cured primer and sanded smooth with 400-grit sandpaper. Take 100 g each of A, A1, and A2, add 10 g water, and adjust the viscosity to 20-25 seconds using a Rockwell cup. Spray A, A1, and A2 onto the marked MDF panels using a Japanese Wata W-71-1.5 spray gun to achieve a 40 μm film thickness. Ensure microbubbles disappear within 10 seconds, with no orange peel texture or ripples, presenting a mirror-smooth surface. After 10 minutes of drying with 80-120 W/cm² energy at 390 nm wavelength from Shenzhen Changyao Light Source Co., Ltd.s three-lamp drying line at room temperature, dry at 60° C. for 30 minutes. Test the dried film characteristics using LEDUV equipment at 6 m/min. Simultaneously prepare another 400×400 cm MDF panel coated with primer and sanded smooth with 400-grit sandpaper. Take 100 g of A3, adjust the viscosity to 20-25 seconds using a Rockwell cup. The A3 material was sprayed onto the pre-marked medium-density fiberboard using Japans Wata W-71-1.5 spray gun to achieve a 40 μm film thickness. After 7 days of drying at 25° C., the dried film properties were analyzed using an LEDUV device at 6 m/min. Comparative tests were conducted on glossiness, adhesion, hardness, complete drying time, film replacement at 80° C., transparency, and yellowing resistance. Glossiness was measured according to ASTM D523 using a gloss meter, while adhesion was evaluated using ISO 2409 with a scratch tester and test tape. Hardness was measured using a pencil hardness tester according to ISO 15184-1998, and yellowing resistance was tested with an ultraviolet aging chamber per GB/T 23983-2009. The results are as follows:

| sample | A | A1 | A2 | A3 |
|---|---|---|---|---|
| glossiness | 50° | 35° | 8° | 30° |
| adhesiveness | Level 0 | Level 0 | Level 0 | Level 0 |
| hardness | 3 H | 3 H | 3 H | 1 H |
| Total drying | 40 min | 40 min | 40 min | 4 h |
| time | | | | |
| Film | normal | normal | normal | normal |
| replacement at | | | | |
| 80° C. | | | | |
| pellucidity | transparent | transparent | transparent | transparent |
| Anti-yellowing | Level 2 | Level 2 | Level 2 | Level 4 |

As shown in the table, A, A1, and A2 have comparable performance to A3, but A, A1, and A2 outperform A3 in hardness, drying speed, and yellowing resistance.

Although embodiments of the invention have been shown and described, it will be understood by those skilled in the art that various variations, modifications, substitutions and modifications can be made to these embodiments without departing from the principles and spirit of the invention. The scope of the invention is defined by the appended claims and their equivalents.

1. A method for preparing an LEDUV-cured water-based wood coating resin, characterized by the following steps:
The modified UV-curable fluorinated aqueous polyurethane emulsion was added to a stainless steel dispersion tank. Under low-speed dispersion, the preset proportions of polyurethane thickener, preservative, dispersant, defoamer, wetting agent, nano additive, and light-blocking agent were introduced. After 25 minutes of high-speed dispersion, the process was switched to low-speed dispersion. Subsequently, the specified ratios of water-based wax emulsion, defoamer, leveling agent, silicone surfactant, and a modified 35% photoinitiator diacetyl phosphine oxide solution were added. Following another 25 minutes of high-speed dispersion, the LEDUV-curable water-based wood coating resin was prepared.

2. The preparation method of LEDUV-cured water-based wood coatings resin according to claim 1, characterized in that: the specific preparation steps of the improved UV-cured fluorinated water-based polyurethane emulsion include:
Add the quantitative polycarbonate diol to acetone and stir until completely dissolved to obtain polycarbonate diol-acetone solution;
Add the specified amount of 2,2-dihydroxypropionic acid to N,N-dimethylformamide and stir until fully dissolved to obtain the 2,2-dihydroxypropionic acid-N,N-dimethylformamide solution.
Add a certain amount of methacrylic acid-2-hydroxyethyl ester to acetone and stir until completely dissolved to obtain methacrylic acid-2-hydroxyethyl ester-acetone solution;
Nitrogen gas is introduced through the inlet of a four-neck flask equipped with a condenser, nitrogen inlet, stirring bar, and thermometer. Under nitrogen protection, a measured amount of isophorone diisocyanate and dibutyltin dilaurate are added, and the temperature is gradually raised to 45° C. The pre-measured polycarbonate diol-acetone solution is added through a dropping funnel at a rate of 1 drop every 2-3 seconds. The reaction proceeds for 3 hours, with viscosity adjusted using acetone. The free isocyanate content is titrated by the dibutylamine method. Upon reaching the theoretical value, the temperature is gradually increased to 65° C. The pre-measured 2,2-dihydroxymethylpropanoic acid-N,N-dimethylformamide solution is added through the dropping funnel at a rate of 1 drop every 2-3 seconds, followed by another 3-hour reaction. The free isocyanate content is titrated again by the dibutylamine method. After reaching the theoretical value, the pre-measured methacrylic acid-2-hydroxyethyl acetate-acetone solution is added through the dropping funnel at a rate of 1 drop every 2-3 seconds for a half-terminated reaction lasting 3 hours. The free isocyanate content is titrated once more by the dibutylamine method. Upon reaching the theoretical value, the pre-measured azobisisobutyronitrile is added through the dropping funnel at a rate of 1 drop every 2-3 seconds. The temperature is gradually raised to 75° C., and the pre-measured methacrylic acid dodecyl fluorohexyl ester is added through the dropping funnel at a rate of 1 drop every 2-3 seconds for a 6-hour reaction. During this process, viscosity is adjusted using ethyl acetate and acetone. The temperature is gradually cooled to 65° C., and the pre-measured 4-methoxy. The capping reaction between phenol and pentaerythritol tris(3-acryloyl) ester was conducted for 4 hours, with the reaction being confirmed by infrared spectroscopy at 2270 cm⁻¹.⁻¹ The isocyanate peak was completely eliminated, resulting in UV-cured fluorinated polyurethane resin.
Cool the UV-cured fluorinated polyurethane resin to room temperature, add triethylamine in the specified amount, and stir at high speed for 30 minutes. Then add deionized water in the specified amount for emulsification treatment, continue for 1 hour, and let it stand for 12 hours. Remove acetone by rotary evaporation under vacuum conditions to obtain UV-cured fluorinated aqueous polyurethane emulsion.

3. The preparation method of water-based wood coating resin for LEDUV curing as claimed in claim 2, characterized in that: the polyurethane diol is added in an amount of 160 ml, 2,2-dihydroxymethylpropanediol (2,2-DMPA) in an amount of 13.4 g, 2-hydroxyethyl methacrylate (HEMA) in an amount of 13 ml, isophorone diisocyanate (IDI) in an amount of 88.9 ml, dodecyl fluoroheptanoate (DFH) in an amount of 19.5 ml, pentaerythritol triacrylate (PTA) in an amount of 29.8 ml, and deionized water in an amount of 680 ml.

4. The preparation method of LEDUV-curable water-based wood coatings resin according to claim 3, characterized in that: the specific preparation steps of the improved 35% photoinitiator diacetyl phosphine oxide solution include:
Add the measured amount of dimethylmethane to the three-neck flask and stir at low speed. Slowly add the measured amount of photoinitiator diacetyl phosphine oxide, pass inert gas, and heat to 75° C. Stir for 1 h until completely dissolved to obtain the improved 35% photoinitiator diacetyl phosphine oxide solution.

5. The preparation method of LEDUV-curable water-based wood coatings resin according to claim 4, characterized in that: the addition amount of dimethoxy methane is 65 ml, and the addition amount of photoinitiator diphosphine oxide is 35 ml.

6. The preparation method of LEDUV-curing water-based wood coatings resin according to claim 5, characterized in that: the polyurethane thickener is RM8W produced by Dow Chemical Company of the United States; the preservative is LEX produced by Rohm and Haas Company of the United States; the dispersant is TEGO Dispers 760W produced by Evonik Industries of Germany; the defoaming agent is TEGO Foamex 825 produced by Evonik Industries of Germany; the wetting agent is TEGO Wet 270 produced by Evonik Industries of Germany; the nano additive is Fumed Silica A200 produced by Degussa Group of Germany; the light-blocking agent is K-500 produced by Toyo Kasei Corporation of Japan; the water-based wax emulsion is 2558 produced by Longhai Chemical Company; the defoaming agent is TEGO Foamex 810 produced by Evonik Industries of Germany; the leveling agent is BYK378 produced by Bick Chemical of Germany; the silicone surfactant is DC57 produced by Dow Corning Company of the United States.

7. The preparation method of LEDUV-curable water-based wood coatings resin according to claim 6, characterized in that: the improved UV-curable fluorinated water-based polyurethane emulsion, polyurethane thickener, preservative, dispersant, defoamer, wetting agent, nano additive, light-blocking agent, water-based wax emulsion, leveling agent, silicone surfactant, and 35% improved photoinitiator diacetyl phosphine oxide solution are added in the following proportions: 86.4%: 0.5%: 0.5%: 0.5%: 0.2%: 0.4%: 0.5%: 4%: 3.5%, 0.2%, 0.4%, 0.4%, and 2.5%.

8. The application of the LEDUV-curable water-based wood coating resin prepared by the method of claim 7 in the field of wood furniture spraying.
